(19) United States
(12) Patent Application Publication
(10) Pub. No.: US 2021/0259907 A1
(43) Pub. Date: Aug. 26, 2021

(54) LEG SUPPORT ACCESSORY FOR A MEDICAL SCOOTER

(71) Applicant: MIDWEST MEDEQ LLC, Gretna, NE (US)

(72) Inventors: TAD VOLLMAR, PAPILLION, NE (US); QUINTON K. DAY, GRETNA, NE (US)

(73) Assignee: MIDWEST MEDEQ LLC, GRETNA, NE (US)

(21) Appl. No.: 17/186,254

(22) Filed: Feb. 26, 2021

Related U.S. Application Data
(60) Provisional application No. 62/981,617, filed on Feb. 26, 2020.

(51) Int. Cl. A61H 3/04

(52) U.S. Cl. CPC A61H 3/04; A61H 2003/005

(57) ABSTRACT

The present invention relates in general to leg support accessories for medical scooters, and more specifically, to a leg support accessory and method of use that elevates a compromised leg of a patient to reduce swelling and promote healing during recovery. One aspect of the leg support accessory includes a vertical member that is connected to an existing frame of a medical scooter. An elongated member may extend forward from the vertical member and include a U-shaped bracket which receives and secures a foot support. The foot support includes a closed lower end for receiving a foot and curves upwardly to contour to a heel and calf of the patient. The angle of the foot support may be adjusted for comfort. The leg support accessory is capable of being adjusted to be used for either the patient's right or left leg, depending on need. The vertical member may also be rotated to a desired position to allow easy entry and exit to and from the medical scooter while providing optimal comfort and support for the compromised leg of the patient during use.

### CROSS-REFERENCE TO RELATED APPLICATIONS

This application claims priority under 35 U.S.C. § 119 to U.S. Provisional Patent Application No. 62/981,617 filed Feb. 26, 2020, herein incorporated by reference in its entirety.

### FIELD OF THE INVENTION

The present invention relates to the field of medical scooters, more particularly, a leg support accessory for a medical scooter that provides elevated support to a compromised leg of a patient.

### BACKGROUND OF THE INVENTION

Patients recovering from a knee, leg, ankle, or foot injury or surgery often require their compromised leg to be kept in a non-weight bearing position for an extended period of time during recovery. While crutches and wheelchairs have traditionally been used to provide weight bearing relief to such patients, medical scooters are now becoming a popular alternative. Medical scooters are often less painful to use, safer to operate, cause less fatigue to the patient, improve stability and offer a higher degree of freedom of movement as compared to traditional crutches and wheelchairs. Medical scooters come in several different forms and varieties. For example, medical scooters may be manually-operated, such as a knee walker or a seated knee scooter, or motorized, such as a three-wheeled or four-wheeled mobility scooter.

Medical scooters require the compromised leg of the patient to rest in a standard, non-elevated position. For example, a knee walker requires the patient to remain in a standing position while resting the knee of the compromised leg at an approximate 90° angle on a padded platform. The patient's healthy leg may be utilized to manually propel the device forward while handlebars set at waist level allow the patient to navigate through obstacles. Another example of a medical scooter, the seated knee scooter, allows the patient to sit on a seat like a bicycle. The seated knee scooter requires the patient's compromised leg to rest on a peg located low and towards the front of the scooter. Similar to the knee walker, the patient's healthy leg may be used to manually propel the device forward while handlebars allow the patient to steer. Yet another example of a medical scooter, the motorized mobility scooter, also requires the legs of the patient—including the compromised leg—to rest together on a platform positioned close to the ground for convenience in getting on and off the device.

Such standard, non-elevated positions currently offered by medical scooters for the patient's compromised leg, however, are often in direct contravention of instructions by the patient's physician to maintain the injured extremity in an elevated position to reduce swelling and promote healing. Indeed, elevation of the leg is key for the patient's comfort and critical for enhancing the healing process. Another problem with only offering a standard, non-elevated position is that the patient's compromised leg may not be in an optimal and comfortable position depending on the patient's particular injury, overall height or weight. If the patient's compromised leg is not in an optimal and comfortable position depending on the particular needs and characteristics of the patient, it could exasperate the injury and cause further harm. Yet another problem with only offering a standard, non-elevated position for the patient's compromised leg is that it could imbalance the medical scooter while maneuvering or when the patient is getting on or off the device, wherein the patient could fall and suffer additional injuries.

For these reasons a desire remains to provide a leg support accessory for a medical scooter that elevates the compromised leg of the patient during use to reduce swelling and promote healing. What is also needed is a leg support accessory for a medical scooter that may be adjustable to allow for optimal positioning of the compromised leg by the patient depending on their particular needs and characteristics. A further desire remains to provide a leg support accessory for a medical scooter that may be adjustable by the patient to ensure the medical scooter is properly balanced while maneuvering or when the patient is getting on or off the device for improved safety.

### BRIEF SUMMARY OF THE INVENTION

According to one aspect of the present disclosure, a leg support accessory for a medical scooter is provided. The leg support accessory may include an attachment mechanism, a vertical member comprising a first end and an opposite second end, an elongated member comprising a proximal end and a distal end, a U-shaped bracket, and a foot support. In particular, the attachment mechanism may be configured to connect the leg support accessory to the medical scooter. The first end of the vertical member may be connected to the attachment mechanism. The second end of the vertical member may be rotatably coupled to the proximal end of the elongated member via the pivot joint, wherein the elongated member is adjustable. The distal end of the elongated member may comprise the U-shaped bracket. The U-shaped bracket may be configured to receive and secure the foot support, wherein the foot support is structured to secure a compromised leg or foot of a patient. A padded surface may also be included on the elongated member to provide further comfort to the patient during use. The leg support accessory is structured to maintain a compromised leg or foot of the patient in an elevated position to reduce swelling, promote healing and provide comfort.

According to another aspect of the present disclosure, a leg support accessory for a medical scooter is provided. The leg support accessory may include an attachment mechanism, a vertical member comprising a first end and an opposite second end, an elongated member comprising a proximal end and a distal end, a U-shaped bracket, and a foot support. In particular, the attachment mechanism may be configured to connect the leg support accessory to the medical scooter. The first end of the vertical member may be rotatably coupled to the attachment mechanism via the pivot joint, wherein the vertical member is capable of rotating about a longitudinal axis. The second end of the vertical member may be fixedly secured to the proximal end of the elongated member at an angle. The distal end of the elongated member may comprise the U-shaped bracket. The U-shaped bracket may be configured to receive and secure the foot support, wherein the foot support is structured to secure a compromised leg or foot of a patient. A padded surface may also be included on the elongated member to provide further comfort to the patient during use. The leg support accessory is structured to maintain a compromised leg or foot of the patient in an elevated position to reduce swelling, promote healing and provide comfort.

According to further aspect of the present disclosure, a method of using the leg support accessory of the present disclosure is provided. The method may include providing a patient having a compromised leg, albeit through injury or surgery for example, in need of rehabilitation. The method may further include providing the leg support accessory of the present disclosure, along with a medical scooter. The leg support accessory may be connected to the medical scooter via an attachment mechanism, wherein the compromised leg may be maintained in an elevated position to reduced swelling, promote healing and provide comfort.

### Principal Objects and Advantages of the Invention

Therefore, it is a principal object, feature, and/or advantage of the present disclosure to overcome the aforementioned deficiencies in the art and provide a leg support accessory for a medical scooter that elevates the compromised leg of the patient during use to reduce swelling and promote healing.

Another object, feature, and/or advantage of the present disclosure is to provide a leg support accessory for a medical scooter that may be adjustable to allow for optimal positioning of the compromised leg by the patient depending on their particular needs and characteristics.

Yet another object, feature, and/or advantage of the present disclosure is to provide a leg support accessory for a medical scooter that may be adjustable by the patient to ensure the medical scooter is properly balanced while maneuvering or when the patient is getting on or off the device for improved safety.

A further object, feature, and/or advantage of the present disclosure is to provide a leg support accessory for a medical scooter that may be used on the left or right side of the medical scooter and thus capable of being used for either the patient's right or left leg, depending on need.

A still further object, feature, and/or advantage of the present disclosure is to provide a leg support accessory for a medical scooter that is quickly attachable and detachable from the medical scooter for ease of assembly and disassembly.

Another object, feature, and/or advantage of the present disclosure is to provide a leg support accessory for a medical scooter that is compatible with different types, sizes and manufacturers of boots, casts and splints.

Yet another object, feature, and/or advantage of the present disclosure is to provide a leg support accessory for a medical scooter that is compatible with different types, sizes and manufacturers of medical scooters.

A further object, feature, and/or advantage of the present disclosure is to provide a leg support accessory for a medical scooter that is lightweight in design and a low cost for patients to purchase.

Other objects, features, and advantages of this disclosure will become apparent from the following description taken in conjunction with the accompanying drawings wherein are set forth, by way of illustration and example and without limitation, certain aspects of this disclosure. The present disclosure is not to be limited to or by these objects, features, and advantages. No single aspect need provide each and every object, feature, or advantage.

### BRIEF DESCRIPTION OF THE FIGURES

FIGS. 1-17 represent examples of a leg support accessory of the present disclosure.

FIG. 1 is a perspective view of a medical scooter as being used by a patient.

FIG. 2 is a perspective view of a first aspect of the leg support accessory of the present disclosure connected to the medical scooter of FIG. 1 as being used by the patient.

FIG. 3 is a left side view of the leg support accessory shown in FIG. 2 connected to the left side of the medical scooter.

FIG. 4 is a right side view of the leg support accessory shown in FIGS. 2-3 connected to the left side of the medical scooter.

FIG. 5 is a front view of the leg support accessory shown in FIGS. 2-4 connected to the left side of the medical scooter.

FIG. 6 is a rear view of the leg support accessory shown in FIGS. 2-5 connected to the left side of the medical scooter.

FIG. 7 is a top view of the leg support accessory shown in FIGS. 2-6 connected to the left side of the medical scooter.

FIG. 8 #is a bottom view of the leg support accessory shown in FIGS. 2-7 connected to the left side of the medical scooter.

FIG. 9 is a perspective view of the leg support accessory shown in FIGS. 2-8 connected to the right side of the medical scooter.

FIG. 10 is a perspective view of a second aspect of the leg support accessory of the present disclosure connected to the medical scooter of FIG. 1 as being used by the patient.

FIG. 11 is a left side view of the leg support accessory shown in FIG. 10.

FIG. 12 is a right side view of the leg support accessory shown in FIGS. 10-11.

FIG. 13 is a magnified view of the leg support accessory shown in FIGS. 10-12 connected to the medical scooter.

FIG. 14 is a front view of the leg support accessory shown in FIGS. 10-13.

FIG. 15 is a rear view of the leg support accessory shown in FIGS. 10-14.

FIG. 16 is a top view of the leg support accessory shown in FIGS. 10-15.

FIG. 17 #is a bottom view of the leg support accessory shown in FIGS. 10-16.

### DETAILED DESCRIPTION OF THE INVENTION

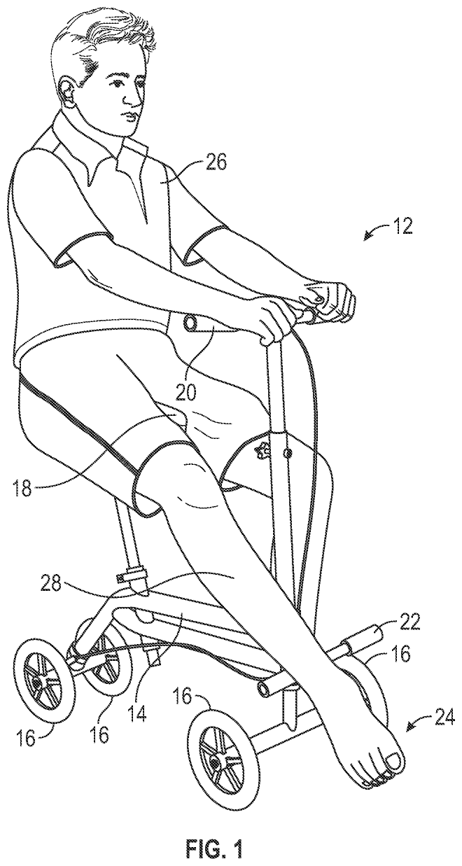

Referring generally to FIGS. 1-17, the present disclosure is directed to a leg support accessory 10, 100 connected to a medical scooter 12 and a method of using the leg support accessory 10, 100. While certain aspects of the present disclosure are shown and described herein, it is understood that such aspects are merely exemplary. The present disclosure is not intended to be limited to these specific aspects and may encompass other aspects or embodiments. Therefore, specific structural and functional details disclosed herein are not to be interpreted or inferred as limiting, but merely as a basis for the claims and as a representative basis for teaching one skilled in the art how to make and use the disclosed subject matter.

FIG. 1 illustrates a perspective view of the medical scooter 12 as being used by a patient 26. The medical scooter 12 may comprise a frame 14 that includes a plurality of wheels 16, a height adjustable seat 18 (e.g., bicycle seat), steerable handlebars 20, and a peg 22 configured for resting the patient's compromised leg 28 in a standard, non-elevated position 24 located low and towards the front of the medical scooter 12. While FIG. 1 shows one example of a medical scooter 12, specifically a manually-operated seated knee scooter, it is contemplated by the present disclosure that the leg support accessory 10, 100 may also be utilized in connection with other types of medical scooters 12 such as a manually-operated knee walker or a motorized three-wheeled or four-wheeled mobility scooter.

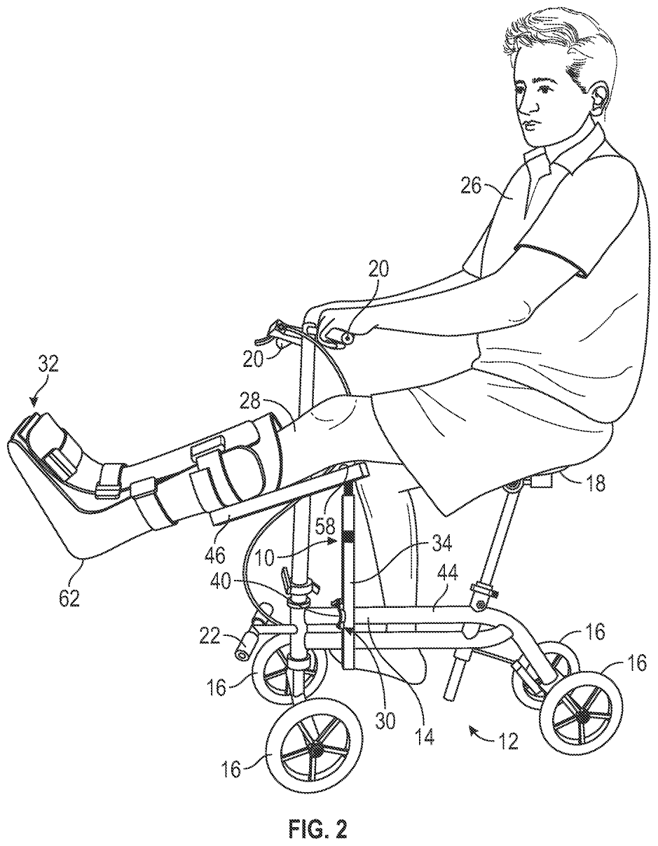

FIG. 2 illustrates a perspective view of a first aspect of the leg support accessory 10 connected to the medical scooter 12 as being used by the patient 26. In particular, the leg support accessory 10 may be connected to the frame 14 of the medical scooter 12 via an attachment mechanism 30. The attachment mechanism 30 may be permanently affixed to the frame 14 wherein the leg support accessory 10 is sold together with the medical scooter 12 to consumers. Alternatively, the attachment mechanism 30 may be separate from the frame 14 wherein the leg support accessory 10 is sold as an aftermarket, add-on accessory for the medical scooter 12.

Shown in FIG. 2, the leg support accessory 10 is configured to provide an elevated position 32 for the compromised leg 28 of the patient 26 #as compared to the standard, non-elevated position 24 of the peg 22 of the medical scooter 12. In particular, the elevated position 32 of the leg support accessory 10 may be approximately 2-4 feet above the ground. In comparison, the standard, non-elevated position 24 of the peg 22 of the medical scooter 12 is typically 6-10 inches above the ground. The elevated position 32 of the leg support accessory 10 is structured to help reduce swelling and promote healing to the patient 26 during use. The elevated position 32 of the leg support accessory 10 is also structured to enable the compromised leg 28 to fully extend to provide optimal comfort to the patient 26.

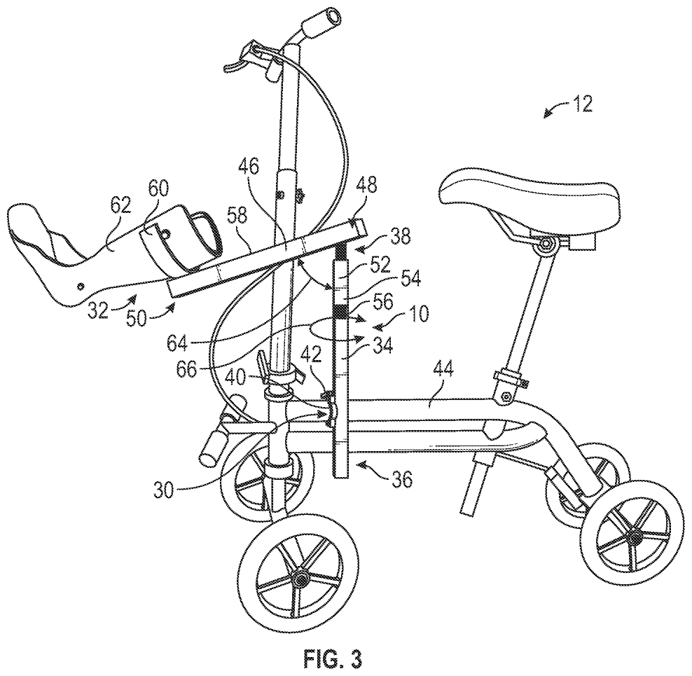

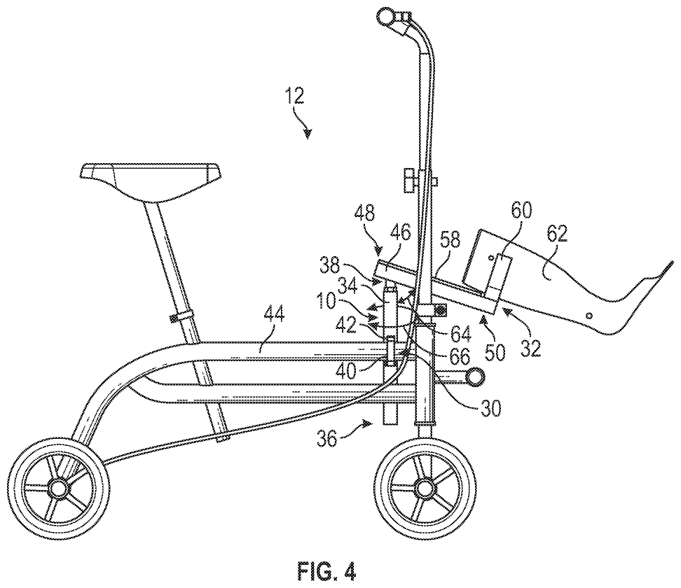

FIGS. 3-4 illustrate left and right side views, respectively, of the leg support accessory 10 connected to a left side of the medical scooter 12. In particular, the leg support accessory 10 may comprise a vertical member 34 having a first end 36 and an opposite second end 38. The first end 36 of the vertical member 34 may comprise the attachment mechanism 30 for rigidly connecting the leg support accessory 10 to the frame 14 of the medical scooter 12. The attachment mechanism 30 may include a clamped assembly 40 having a quick release mechanism 42 that allows the vertical member 34 of the leg support accessory 10 to be rapidly connected to or released from a horizontal tubular member 44 of the frame 14 of the medical scooter 12. Examples of suitable clamped assemblies 40 may comprise lever clamps, screw clamps, toggle clamps, hinge clamps, pipe clamps, worm gear clamps, torque clamps, and others. The attachment mechanism 30 may include additional devices for connecting or releasing the vertical member 34 to the horizontal tubular member 44 of the frame 14, such as utilizing U-shaped bolts with nuts. Alternatively, the attachment mechanism 30 may be permanently affixed to the tubular member 44 of the frame 14 using, e.g., welds, adhesives, screws, or integrally formed together. The attachment mechanism 30 may further be configured to provide for the height of the vertical member 34 to be adjustable relative to the frame 14 of the medical scooter 12.

Shown in FIGS. 3-4, the leg support accessory 10 may further comprise an elongated member 46 having a proximal end 48 and an opposite distal end 50. The proximal end 48 of the elongated member 46 may be rotatably coupled to the second end 38 of the vertical member 34 via a pivot joint 52. The pivot joint 52 may comprise, for example, a hollow tube 54 mounted on the vertical member 34 and a pin 56 mounted on the elongated member 46. The pin 56 may be positioned within the hollow tube 54, wherein the pin 56 is configured to rotate therein. Alternatively, other types of pivot joints 52 may be utilized that provide for the proximal end 48 of the elongated member 46 to be rotatably coupled to the second end 38 of the vertical member 34, such as ball and socket joints, condyloid joints, saddle joints, hinge joints, swivel joints and others. A locking mechanism may also be incorporated to secure the elongated member 46 in position relative to the vertical member 34. A dorsal side of the elongated member 46 may further comprise a padded surface 58. During use, the compromised leg 28 of the patient 26 may rest on the padded surface 58 of the elongated member 46 to provide additional comfort to the patient 26.

Further shown in FIGS. 3-4, the leg support accessory 10 may also comprise a U-shaped bracket 60 mounted on the dorsal side of the distal end 50 of the elongated member 46. The U-shaped bracket 60 may be configured to removably receive and secure a foot support 62 for the compromised leg 28 of the patient 26. The U-shaped bracket 60 may be universal to fit a foot support 62 for any size or age of the patient 26 (e.g., toddlers, preschoolers, children, teens, adults and plus size). The U-shaped bracket 60 may also be adjustable to fit different types of foot supports 62, such as those having external hardware, internal hardware, a walking boot, a cast, or splint. #The angle of the foot support 62 within the U-shaped bracket 60 may be adjustable for the patient's 26 optimal comfort. Moreover, the foot support 62 may be secured by the U-shaped bracket 60 along any length of the elongated member 46, such that the leg support accessory 10 is compatible with patients' 26 having various leg lengths.

Also shown in FIGS. 3-4, the leg support accessory 10 may comprise a vertical angle 64 formed by the vertical member 34 and elongated member 46. The vertical angle 64 may be adjustable via the pivot joint 52. The patient 26 may adjust the vertical angle 64 forward and aft to set their compromised leg 28 at an optimal angle for maximum comfort, depending on the patient's 26 particular needs and characteristics, such as their height, weight, size and specific injury.

The elongated member 46 may also comprise a longitudinal axis of rotation 66 around the vertical member 34. The longitudinal axis of rotation 66 may be adjustable because the elongated member 34 is pivotally secured to the vertical member 34 via the pivot joint 52. The patient 26 may adjust the longitudinal axis of rotation 66 left and right to ensure that the medical scooter 12 is properly balanced during use and easy to maneuver in tight places. The patient 26 may further adjust the longitudinal axis of rotation 66 to provide for optimal positioning of their compromised leg 28 during use for maximum comfort. The patient 26 may also adjust the longitudinal axis of rotation 66 to move the elongated member 46 to a desired position to provide for easy entry and exit to and from the medical scooter 12. In particular, the elongated member 46 may be cambered forward with respect to the vertical member 34 such that after the compromised leg 28 is removed from the leg support accessory 10, gravity pulls the elongated member 46 inwards to provide room for the patient 26 to exit the medical scooter 12 in a safe manner.

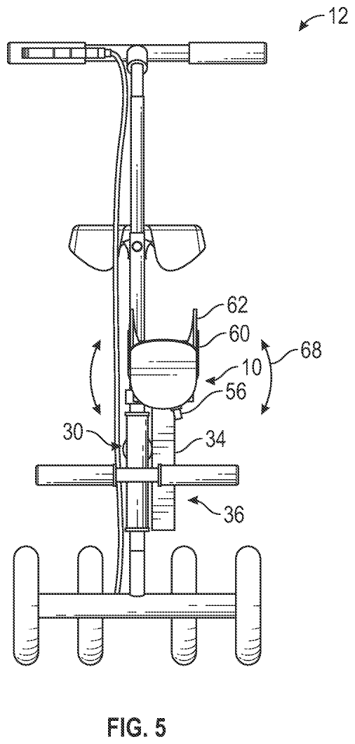

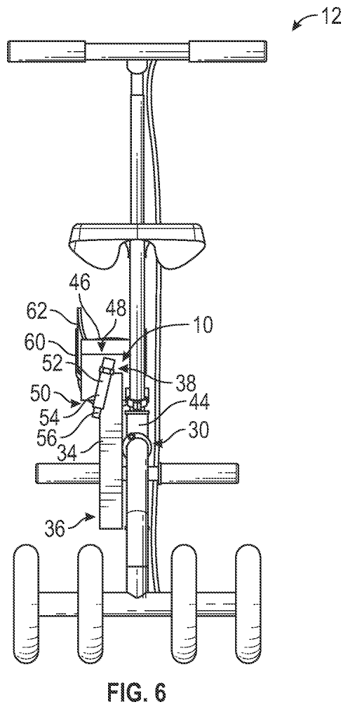

FIGS. 5-6 illustrate front and rear views, respectively, of the leg support accessory 10 connected to a left side of the medical scooter 12. The elongated member 46 of the leg support accessory 10 may further comprise a roll axis of rotation 68 that enables the elongated member 46 to tilt sideways about the pivot joint 52. The roll axis of rotation 68 may be adjustable via the pivot joint 52, wherein the patient 26 may adjust the roll axis of rotation 68 to provide for optimal positioning of their compromised leg 28 for maximum comfort during use.

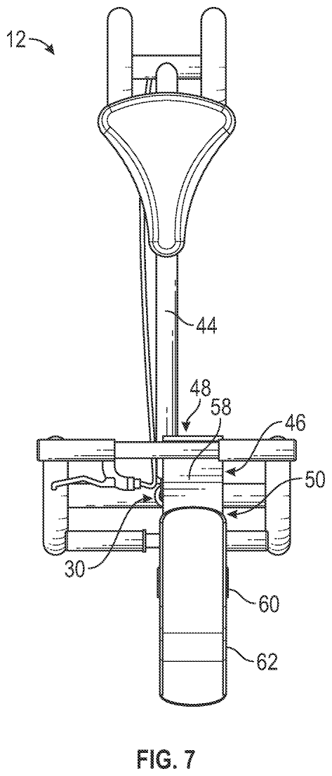

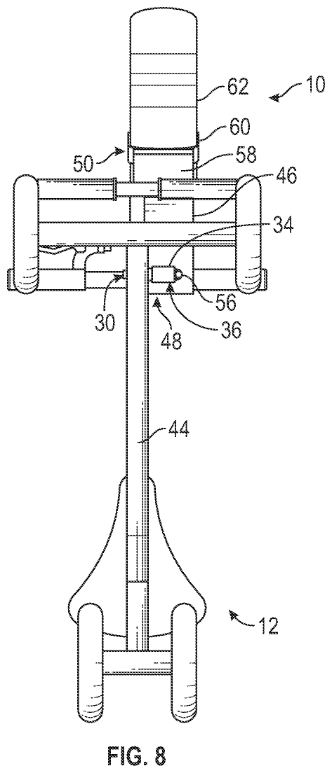

FIGS. 7-8 illustrate top and bottom views, respectively, of the leg support accessory 10 connected to a left side of the medical scooter 12. The leg support accessory 10 may comprise foot support 62 having a boot shaped body with an open dorsal side and a closed ventral side, such that the patient 26 may removably place a compromised leg or foot therein. The foot support 62 may comprise a closed lower end for receiving the foot, wherein the foot support 62 curves upwardly to contour to the heel and calf of the patient 26. The foot support 62 may include interior padding, such that the compromised leg 28 of the patient 26 may be provided additional comfort when secured therein.

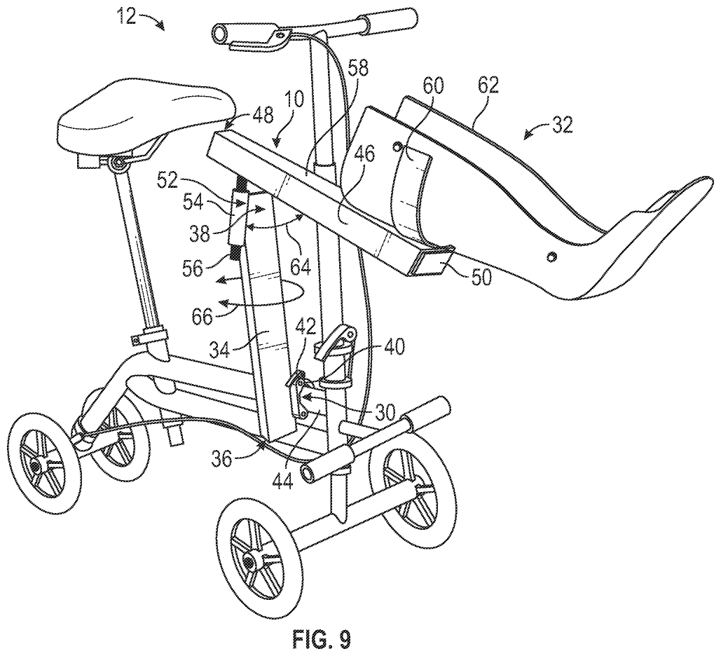

FIG. 9 illustrates a perspective view of the leg support accessory shown in FIGS. 2-8 connected to the right side of the medical scooter. In particular, the leg support accessory 10 may be connected to the right side of the frame 14 of the medical scooter 12 using the attachment mechanism 30 in a similar manner as set forth above with respect to the left side of the medical scooter 12. The leg support accessory 10 of the present disclosure is universally applicable for use on the left or right side of a medical scooter 12 and thus capable of being used for either the patient's 26 right or left leg, depending on need. Thus the leg support accessory 10 of the present disclosure is configured to provide the patient 26 with the ability to adjust camber, caster, angle and height of the foot support 62 and U-shaped bracket 60 connected to the elongated member 46 for optimal comfort settings preferred by the patient 26.

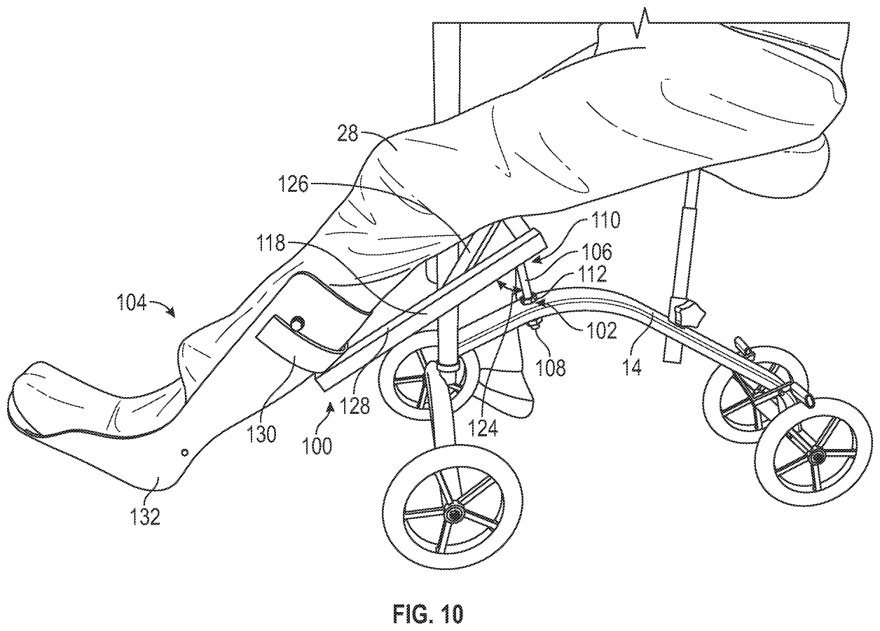

FIG. 10 illustrates a perspective view of a second aspect of a leg support accessory 100 connected to the medical scooter 12 as being used by the patient 26. In particular, the leg support accessory 100 may be connected to a frame 14 of the medical scooter 12 via attachment mechanism 102. The attachment mechanism 102 may be permanently affixed to the frame 14 wherein the leg support accessory 100 is sold together with the medical scooter 12 to consumers. Alternatively, the attachment mechanism 102 may be separate from the frame 14 wherein the leg support accessory 100 is sold as an aftermarket, add-on accessory for the medical scooter 12.

Shown in FIG. 10, the leg support accessory 100 is configured to provide an elevated position 104 for the compromised leg 28 of the patient 26 #as compared to the standard, non-elevated position 24 of the peg 22 of the medical scooter 12. In particular, the elevated position 104 of the leg support accessory 100 may be approximately 2-4 feet above the ground. The elevated position 104 of the leg support accessory 100 is structured to help reduce swelling and promote healing to the patient 26 during use. The elevated position 104 of the leg support accessory 100 is also structured to enable the compromised leg 28 to fully extend to provide optimal comfort to the patient 26.

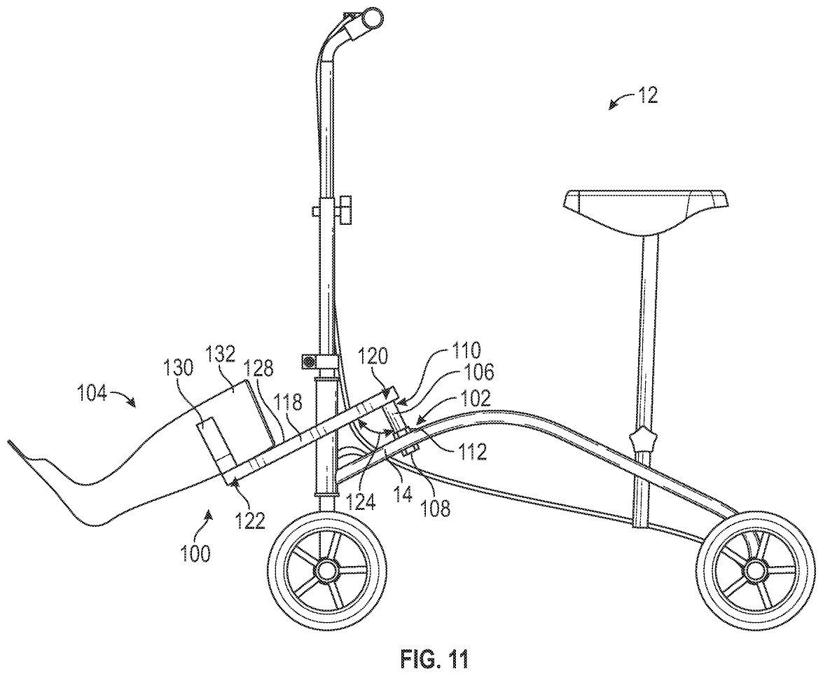

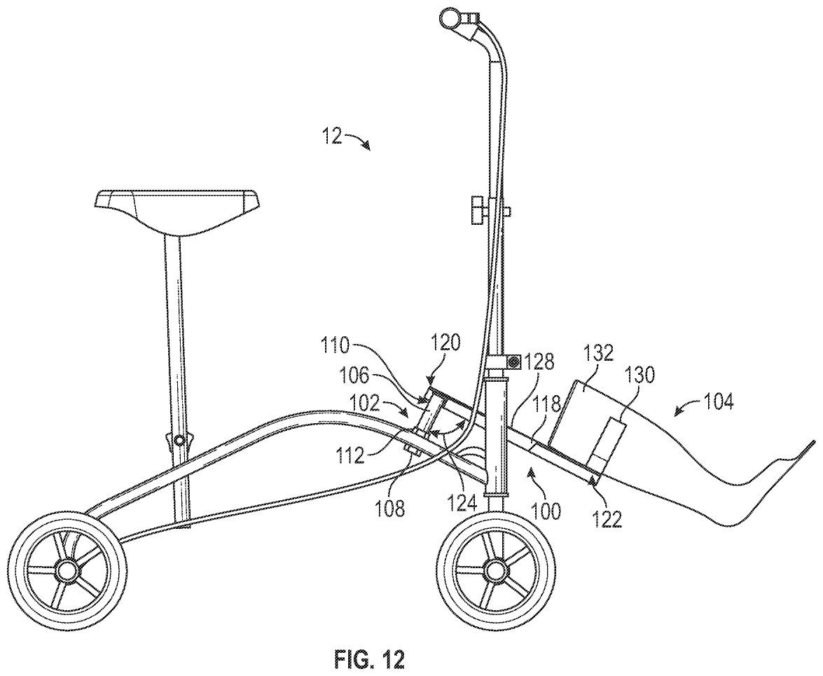

FIGS. 11-12 illustrate left and right side views, respectively, of the leg support accessory 100 connected to the medical scooter 12. In particular, the leg support accessory 100 may comprise a vertical member 106 having a first end 108 and an opposite second end 110. The first end 108 of the vertical member 106 may comprise the attachment mechanism 102 for rotatably connecting the leg support accessory 100 to the frame 14 of the medical scooter 12, wherein the attachment mechanism 102 may comprise a pivot joint 112.

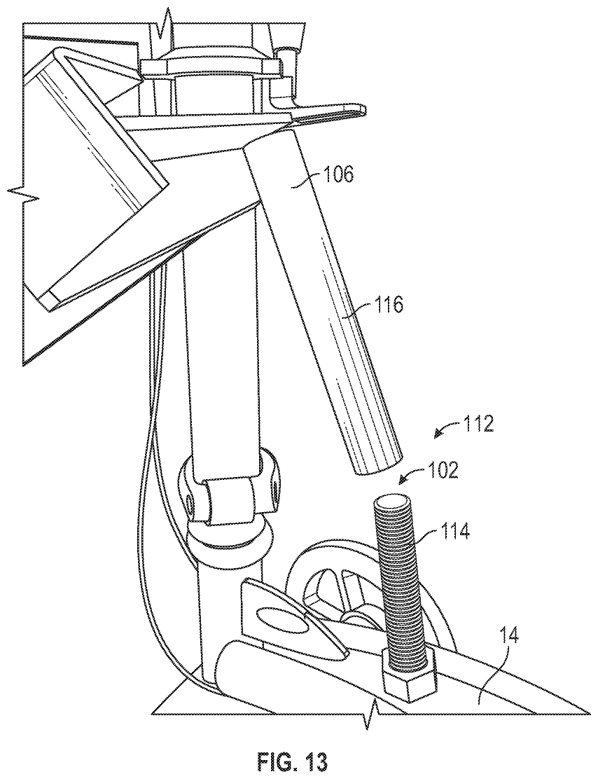

FIG. 13 illustrates a magnified view of the leg support accessory 100 connected to the medical scooter via the pivot joint 112. In particular, the pivot joint 112 may comprise a rod 114 extending vertically up from the frame 14 of the medical scooter 12. The rod 114 may be configured to fit inside a hollow chamber 116 within the vertical member 106. The vertical member 106 is pivotally secured over the rod 114, such that the vertical member 106 is capable of rotating about a longitudinal axis thereof. Alternatively, other types of pivot joints 112 may be utilized, such as ball and socket joints, condyloid joints, saddle joints, hinge joints, swivel joints and others. Because the vertical member 106 is capable of rotating about a longitudinal axis, the leg support accessory 10 is universally applicable for use on the left or right side of a medical scooter 12 and thus capable of being used for either the patient's 26 right or left leg, depending on need. A locking mechanism may also be incorporated to secure the vertical member 106 in position relative to the frame 14 of the medical scooter 12.

Shown in FIGS. 11-13, the leg support accessory 100 may further comprise an elongated member 118 having a proximal end 120 and an opposite distal end 122. The proximal end 120 of the elongated member 118 may be fixedly secured to the second end 110 of the vertical member 106 at a set angle 124, such that the compromised leg 28 is supported comfortably in the elevated position 104. Alternatively, the proximal end 120 of the elongated member 118 may be hingedly secured to the second end 110 of the vertical member 106 such that the angle 124 may be adjustable in an upward or downward motion. The elongated member 118 may also include at least one angular brace 126 forming an A-frame configured to fully support the weight of the compromised leg 28 of the patient 26 to provide additional structural integrity to the leg support assembly 100. A dorsal side of the elongated member 118 may further comprise a padded surface 128. During use, the compromised leg 28 of the patient 26 may rest on the padded surface 128 of the elongated member 118 to provide additional comfort to the patient 26.

Further shown in FIGS. 11-13, the leg support accessory 100 may also comprise a U-shaped bracket 130 mounted on the dorsal side of the distal end 122 of the elongated member 118. The U-shaped bracket 130 may be configured to removably receive and secure a foot support 132 for the compromised leg 28 of the patient 26. As explained above with respect to the first aspect of the present disclosure, the U-shaped bracket 130 may be universal to fit a foot support 132 for any size or age of the patient 26 (e.g., toddlers, preschoolers, children, teens, adults and plus size). The U-shaped bracket 130 may also be adjustable to fit different types of foot supports 132, such as those having external hardware, internal hardware, a walking boot, a cast, or splint. #The angle of the foot support 132 within the U-shaped bracket 130 may be adjustable for the patient's 26 optimal comfort. Moreover, the foot support 132 may be secured by the U-shaped bracket 130 along any length of the elongated member 118, such that the leg support accessory 100 is compatible with patients' 26 having various leg lengths.

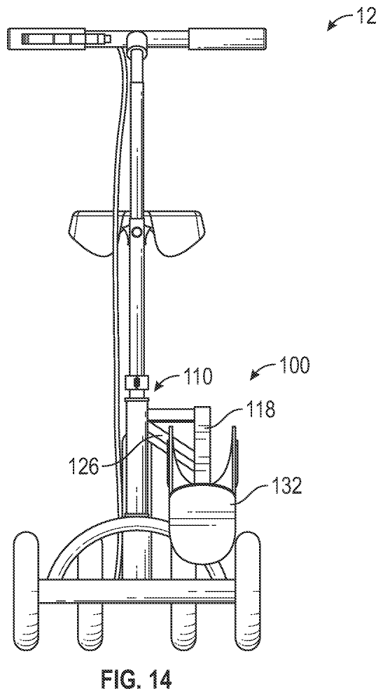

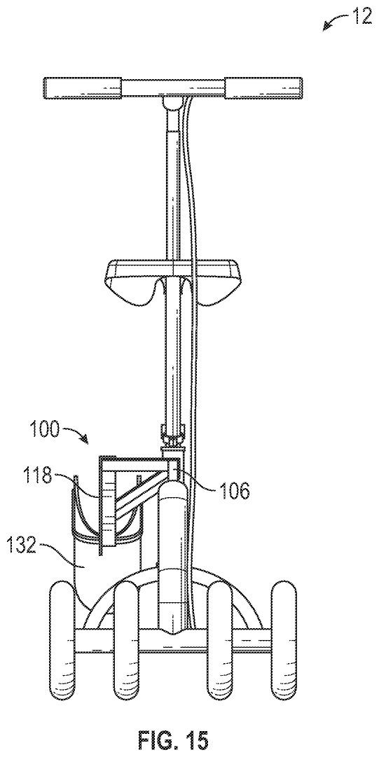

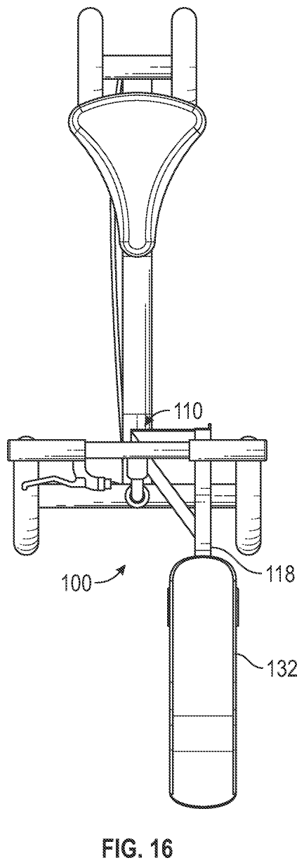

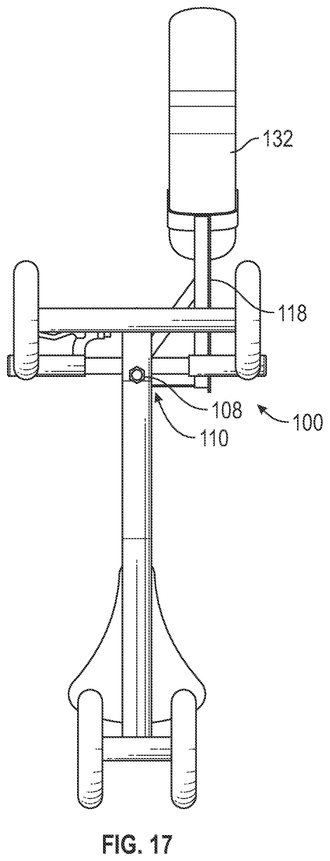

FIGS. 14-15 illustrate front and rear views, respectively, of the leg support accessory 100 connected to the medical scooter 12. FIGS. 16-17 illustrate top and bottom views, respectively, of the leg support accessory 100 connected to the medical scooter 12. The leg support accessory 100 may comprise foot support 132 having a boot shaped body with an open dorsal side and a closed ventral side, such that the patient 26 may removably place a compromised leg or foot therein. The foot support 132 may comprise a closed lower end for receiving the foot, wherein the foot support 132 curves upwardly to contour to the heel and calf of the patient 26. The foot support 132 may include interior padding, such that the compromised leg 28 of the patient 26 may be provided additional comfort when secured therein. Thus the leg support accessory 100 of the present disclosure is configured to provide the patient 26 with the ability to adjust camber, caster, angle and height of the foot support 132 and U-shaped bracket 130 connected to the elongated member 118 for optimal comfort settings preferred by the patient 26.

Another aspect of the present disclosure is a method of using the leg support accessory 10, 100 of FIGS. 2-15. In particular, the method may comprise providing a patient 26 having a compromised leg 28, albeit through surgery or injury for example, that is in need of rehabilitation. The method may further comprise providing a medical scooter 12 as exemplarily set forth in FIG. 1. The leg support accessory 10, 100 of FIGS. 2-15 may also be provided. The method may include connecting the leg support accessory 10, 100 to the medical scooter 12. The patient 26 may then utilize the leg support accessory 10, 100 connected to the medical scooter 12 in a manner as set forth above to maintain the compromised leg 28 in a comfortable and elevated position to reduce swelling and promote healing during the recovery process.

The leg support accessory 10, 100 and method of use of the present disclosure are universally applicable to be connected to and utilized with medical scooters 12 of all makes, models, sizes and manufacturers. #The leg support accessory 10, 100 may be formed from aluminum, metal, and/or plastic components that are fastened together using welds, adhesives, bolts, screws, fasteners, rivets, combinations thereof, or otherwise. While the vertical member 34, 106 and elongated member 46, 118 of the leg support accessory 10, 100 of FIGS. 3-15 are shown as comprising square tubular shapes, it is also contemplated by the present disclosure that a cross section of these tubular shapes may include a circular, rectangular, triangular, polygonal or other enclosed tubular shapes. Although the disclosure has been described and illustrated with respect to preferred aspects thereof, it is not to be so limited since changes, modifications, and combinations thereof may be made which are within the full intended scope of the disclosure.

What is claimed is:

1: A leg support accessory for a medical scooter, comprising:
an attachment mechanism configured to removably connect to a medical scooter;
a vertical member connected to the attachment mechanism;
an elongated member connected to the vertical member;
a pivot joint connecting the vertical member to the elongated member;
a padded surface on the elongated member;
a U-shaped bracket connected to the elongated member;
the U-shaped bracket configured to receive and secure a foot support;
the foot support structured to secure a compromised leg or foot of a patient;
wherein the leg support accessory is structured to maintain a compromised leg or foot of the patient in an elevated position.

2: The leg support accessory of claim 1, further comprising:
the attachment mechanism configured to removably connect the leg support accessory to a medical scooter includes a clamped assembly; and
the clamped assembly removably connects the leg support accessory to a frame of the medical scooter.

3: The leg support accessory of claim 2, wherein the clamped assembly comprises a quick release mechanism and a clamp lever.

4: The leg support accessory of claim 1, wherein the elevated position for the compromised leg is higher than a standard, non-elevated position provided by the medical scooter.

5: The leg support accessory of claim 1, wherein the pivot joint is configured to adjust a vertical angle forward and aft between the vertical member and the elongated member.

6: The leg support accessory of claim 1, wherein the pivot joint is configured to adjust a longitudinal axis of rotation around the vertical member.

7: The leg support accessory of claim 1, wherein the pivot joint is configured to adjust a roll axis of rotation that enables the elongated member to tilt sideways.

8: The leg support accessory of claim 1, further comprising:
an angle of the foot support within the U-shaped bracket configured to be adjustable;
the U-shaped bracket configured to be adjustable to fit different types of foot supports; and
the foot support configured to be secured along any length of the elongated member;
wherein the leg support accessory is compatible with patients having various leg lengths.

9: The leg support accessory of claim 1, further comprising:
the leg support accessory configured for use on a left or right side of the medical scooter; and
the leg support accessory configured to be used for either the patient's right or left leg.

10: The leg support accessory of claim 1, wherein the medical scooter is a seated knee scooter.

11: The leg support accessory of claim 1, wherein the attachment mechanism is separate from the frame and the leg support accessory is configured to be an aftermarket, add-on accessory for the medical scooter.

12: A leg support accessory for a medical scooter, comprising:
an attachment mechanism configured to removably connect to a medical scooter;
the attachment mechanism comprising a pivot joint;
a vertical member connected to the attachment mechanism via the pivot joint;
an elongated member fixedly secured to the vertical member at an angle;
a padded surface on the elongated member;
a U-shaped bracket connected to the elongated member;
the U-shaped bracket configured to receive and secure a foot support;
the foot support structured to secure a compromised leg or foot of a patient;
wherein the leg support accessory is structured to maintain a compromised leg or foot of the patient in an elevated position.

13: The leg support accessory of claim 12, the elongated member comprising at least one angular brace to provide support the compromised leg.

14: The leg support accessory of claim 12, wherein the elevated position for the compromised leg is higher than a standard, non-elevated position provided by the medical scooter.

15: The leg support accessory of claim 12, wherein the pivot joint is configured to adjust a longitudinal axis of rotation around the vertical member.

16: The leg support accessory of claim 12, further comprising:
an angle of the foot support within the U-shaped bracket configured to be adjustable;
the U-shaped bracket configured to be adjustable to fit different types of foot supports; and
the foot support configured to be secured along any length of the elongated member;
wherein the leg support accessory is compatible with patients having various leg lengths.

17: The leg support accessory of claim 12, further comprising:
the leg support accessory configured for use on a left or right side of the medical scooter; and
the leg support accessory configured to be used for either the patient's right or left leg.

18: The leg support accessory of claim 12, wherein the medical scooter is a seated knee scooter.

19: A method of using a leg support accessory, comprising:
providing a patient having a compromised leg in need of rehabilitation;
providing a medical scooter;
providing a leg support accessory, comprising:
a) an attachment mechanism configured to removably connect to the medical scooter;
b) a vertical member connected to the attachment mechanism;
c) an elongated member connected to the vertical member;
d) a pivot joint connecting the vertical member to the elongated member;
e) a padded surface on the elongated member;
f) a U-shaped bracket connected to the elongated member;
g) the U-shaped bracket configured to receive and secure a foot support;
h) the foot support structured to secure the compromised leg of the patient;
i) wherein the leg support accessory is structured to maintain the compromised leg of the patient in an elevated position.
connecting the leg support accessory to the medical scooter via the attachment mechanism; and
maintaining the compromised leg in the elevated position utilizing the leg support accessory.

20: The method of claim 19, further comprising adjusting a vertical angle formed by the vertical member and elongated member using the pivot joint for the patient's maximum comfort.
